(19) United States
(12) Patent Application Publication
(10) Pub. No.: US 2015/0300568 A1
(43) Pub. Date: Oct. 22, 2015

(54) SYSTEM AND METHOD FOR MANUFACTURING PRESSURE UNITS

(71) Applicant: AIROPACK TECHNOLOGY GROUP B.V., RE Waalwijk (NL)

(72) Inventors: Frank SMITS, NN Heesch (NL); Rob HABRAKEN, SH Nunen (NL); Phil REGAN, BC Zaltbommel (NL)

(21) Appl. No.: 14/647,805

(22) PCT Filed: Nov. 28, 2013
(86) PCT No.: PCT/IB2013/060477

§ 371 Date: May 27, 2015

(30) Foreign Application Priority Data
Nov. 28, 2012 (CH) 02601/12

(51) Int. Cl. F17C 1/00; B29C 65/00; B29C 65/16; B65B 53/02

(52) U.S. Cl. CPC F17C 1/00; B65B 53/02; B29C 66/545; B29C 65/16; B29C 66/65; B29L 2031/7142

(57) ABSTRACT

A novel system is described for manufacturing fully automatically pressure units (1) having a high pressure container (2) with a bottom part (3) and a closure (7) with a pressure control device (6), which pressure units (1) are to be mounted in a fluid container (5). In a production line (100) with a first station (110) the bottom part (3) and the closure (7) are mounted automatically to the high pressure container (2). In a second station (130) the bottom part 3) and the closure (7) are welded into the high pressure container (2), and in a third station (160) the containers (50) and the pressure units (1) are pre-assembled. In a fourth station (170) the pressure units (1) are welded into the containers (50).

### FIELD OF THE INVENTION

The invention pertains to a system and a method for manufacturing pressure units.

### BACKGROUND OF THE INVENTION

In WO-A-2005/082744 the manufacturing process of a pressure unit—mentioned here as pressure control device—is described. The cylinder 2 (see FIG. 1) with a closed bottom end and an open upper end of a pressure control device 1 is injection blow moulded from polyethylene terephthalate (PET). A central opening or hole 35 is made in the bottom of the cylinder 2 by drilling or, which is more advantageous, during the injection blow moulding process in that the outer shape of the moulding tool has a pin at the bottom for shaping the central opening or hole. The other parts of the insert 5 with the funnel 6, the cup-like piston 13, the ring cylinder 21 and the cylindrical clamping means are made by injection moulding of any suitable material like PET or the like. The cup-like cylinder made of aluminum is positioned at the correct position over the piston with surrounding O-ring under air pressure. At the open end of the cylinder three or four indentations are made to prevent escape of the piston. In this manner the reference pressure chamber is maintained at a predetermined excess pressure. The container or bottle 50 is injection stretch blow-moulded from a proper pre-form made of any suitable synthetic material like PET. The flexible piston 52 is assembled into the bottle 50 with its open end put over the cylinder 2 of the pressure control device 1. The bottle 50 is then laser-welded to the cylinder 2. After assemblage of the container 50 with the pressure control device 1 the pressure control device is pressurized with air having an overpressure of about 8 bar and the bottom is closed by a rubber plug 37.

The production process of above-mentioned document is only described in principle steps.

It is the object of the present invention to provide a system and a method for fully automatically manufacturing pressure units for pressurizing containers.

This object is accomplished by a system for manufacturing pressure units according to the features of claim 1 and by a method for manufacturing pressure units according to the features of claim 5.

### BRIEF DESCRIPTION OF THE FIGURES

In the following, the invention is described in greater detail, by way of example, with reference to the accompanying drawings.

FIG. 1 a cross-section of a pressure unit in exploded view,

FIG. 2 an insert, an assembled pressure unit and the pressure unit assembled in a plastic container,

FIG. 2 a schematic view on a production line with two different product outputs,

FIG. 4 a scheme of the steps in the manufacturing process for producing assembled pressure units and for producing containers including the pressure units, and

FIG. 5 an alternative production process in which the pressure units are produced and assembled with containers at different locations.

### DETAILED DESCRIPTION

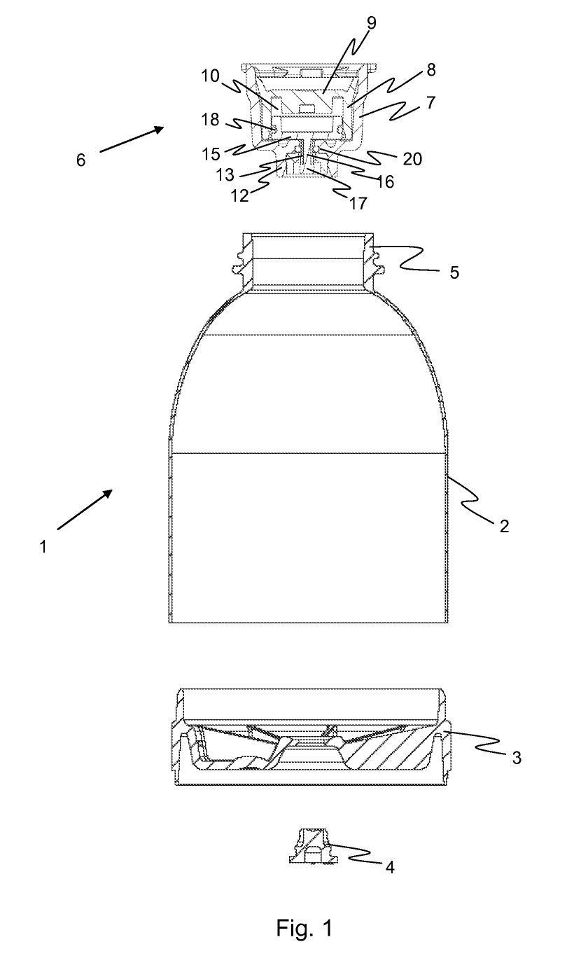

FIG. 1 shows an exploded view of a pressure unit 1. The pressure unit 1 comprises a high pressure container 2 with a bottom part 3 and a plug 4 for closing the pressure container 2 at the bottom. On top of the pressure container 2 a rim 5 is provided for holding a pressure control device 6 which comprises a cuplike closure 7, in which a cylindrical member 8 with a closed upper end 9 is mounted, such that a reference pressure chamber 10 is provided. The bottom part 12 of the cuplike closure 7 has a valve opening 13. In the reference pressure chamber 10 a piston 15 with a downward protruding stem 16 and a cylindrical end stop 17 is adapted. Outside of the piston 15 an O-ring 18 is provided for sealing the piston 15 towards the inner wall of the cylindrical member 8. In the downside end of the valve opening 13 an O-ring 20 is provided which cooperates with the end stop 17. The working of the pressure unit 1 is commensurate to the description of WO-A-2005/082744, which is herewith incorporated by reference.

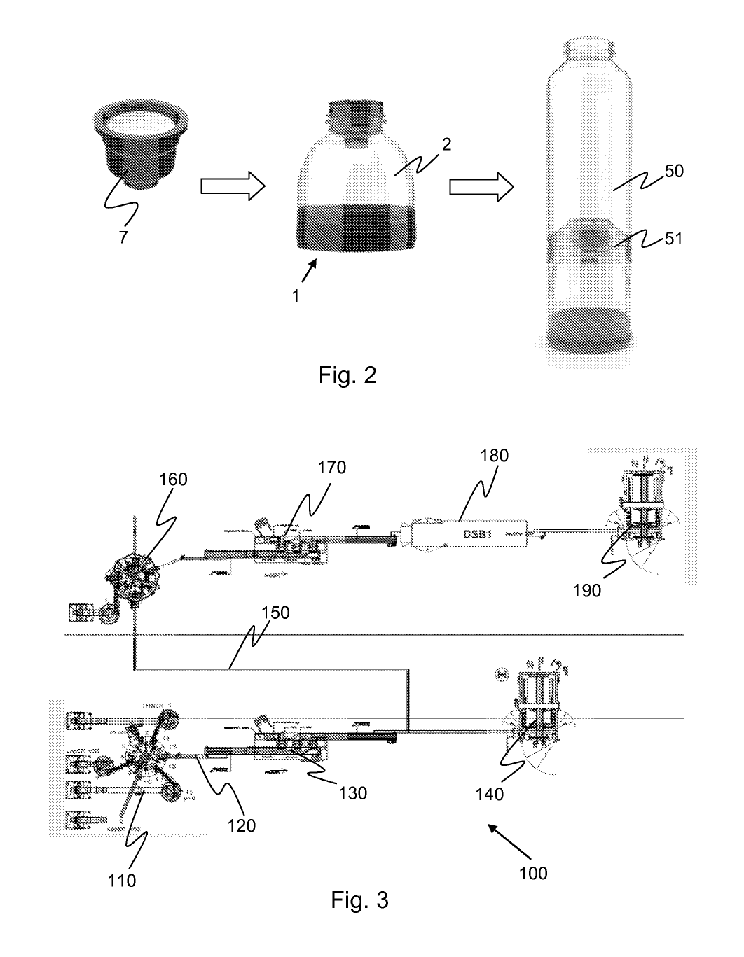

In FIG. 2 the ring-shaped insert or closure 7, the pressure unit 1 with the high pressure container 2 and a container or bottle 50 with a further piston 51 are shown, commensurate to the description of WO-A-2005/082744. The high pressure container 2 in the present configuration is made from a plastic bottle which is formed from a pre-form of PET by stretch blow-moulding. The bottom part of the formed bottle is then cut off and a bottom part 3 is mounted to the high pressure container 2 and the closure 7 is mounted to the top of the high pressure container 2.

In FIG. 3 the production line 100 for producing the pressure unit 1 and for producing the container or bottle 50 for being connected to the pressure unit 1 is depicted. In station 110 the insert 7 and the bottom part 3 are mounted to the high pressure container 2 and are transported by line 120 to the welding station 130, where the ring-shaped inserts 7 and the bottom parts 3 are laser-welded to the high pressure containers 2. For laser welding the assembled high pressure containers 2 are rotated and two lasers are mounted in station 130, wherein the laser beams are directed to the bottom and upper parts of the high pressure container 2. The laser equipment used is NOVALAS-C system of Leister Process Technology, Sarnen, Switzerland. In station 140 the assembled pressure units 1 are bulk packed on a pallet and shrink-wrapped by a foil ready for transportation. On the other hand the assembled pressure units 1 may be transported over line 150 to pre-assembling station 160 in which the pressure units 1 are mounted to the containers 50. After pre-assembling the containers 50 are laser-welded in welding station 170, wherein the bottom part 3 of the pressure unit 1 is laser-welded to the container 50. In this station 170 the pre-assembled pressure unit 1 and the container 50 are also rotated and laser welded. In subsequent station 180 a shrink sleeve with product and producer information (logo, product name, product information etc.) is connected to the container 50 by heating the shrink sleeve. The finished containers 50 are then bulk packed and shrink-wrapped on a pallet in station 190.

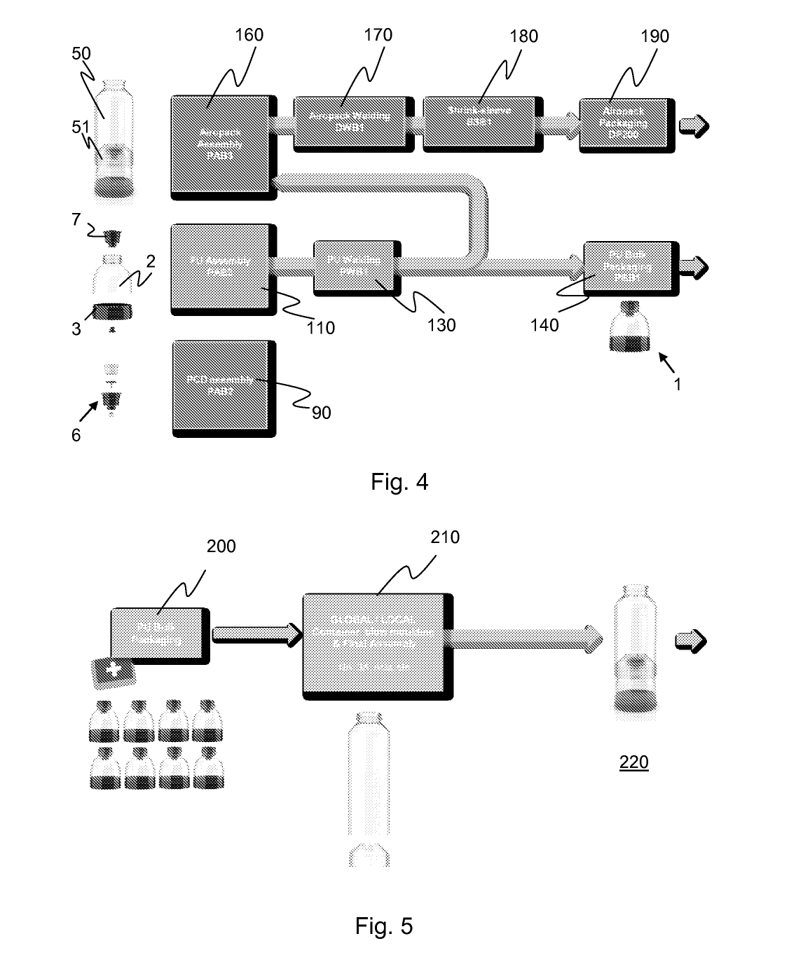

In FIG. 4 the production process commensurate to the production line in FIG. 2 is schematically shown. In a first step 90 the insert or closure 7 is assembled automatically. The pressure control device 6 within the insert or closure 7 is controlling the pressure in the container 50 which is determined by the pressure in the reference pressure chamber 10 (see FIG. 1), the function thereof has been described in detail in WO-A-2005/082744.

In FIG. 5 is depicted the logistics of global manufacturing of pressurized containers 50 in which the filled-in fluid is propelled by normal air with a pressure of e.g. 2 bar. The pressure units 1 are produced in a first factory 200, e.g. in Switzerland, and shipped to factories in other countries all over the world. In those countries there is built a factory 210 for producing containers 50 by the known process of stretch blow-moulding from a pre-form of PET or any other suitable plastic material. In the same factory 210 the containers 50 are assembled with piston 51 and with the pressure unit 1. In another station 220 of the second factory 210 the containers 50 are filled with a fluid according to the needs of the customer (gel, shaving cream, soap, etc.) and capped with a closure valve (not shown). The filled-in containers or bottles 50 are then bulk packe and shrink-wrapped on a pallet for shipping to the customers.

1. A system for fully automatically manufacturing pressure units having a high pressure container with a bottom part and a closure with a pressure control device, which pressure units are to be mounted in a fluid container, comprising a production line with a first station for automatic mounting of the bottom part and the closure to the high pressure container, a second station for welding the bottom part and the closure into the high pressure container, a third station for assembling the fluid containers and the pressure units and a fourth station for welding the fluid containers to the pressure units.

2. The system according to claim 1, further comprising a fifth station for connecting a shrink sleeve over the container by applying heat during a short period of time.

3. The system according to claim 2, further comprising a further station for bulk packing and shrink-wrapping the finished containers.

4. The system according to claim 1, wherein the first and second stations are provided in a first factory and the third and fourth stations are provided in a second factory.

5. A method for fully automatically manufacturing pressure units having a high pressure container with a bottom part and a closure with a pressure control device, which pressure units are to be mounted in fluid container, comprising automatically mounting the closure to the high pressure container, welding the closure and the bottom part into the high pressure container, pre-assemblying the containers and the pressure units and welding the containers to the pressure units.

6. The method according to claim 5, further comprising providing a shrink sleeve over the container by applying heat for a short period of time.

7. The method according to claim 5, further
comprising bulk, packing and shrink-wrapping the finished containers.

8. The method according to claim 5, wherein the pressure units are produced in a first factory and the containers are stretch-blow moulded from a pre-form of plastic material and the containers are welded to the pressure units in a second factory.

9. The system according to claim 1, wherein rotating elements are configured for rotating the high pressure container during welding.

10. The system according to claim 1, further comprising an upper laser and a lower laser, wherein the upper laser and the lower laser are configured for simultaneously welding the closure and the bottom part into the high-pressure container.

11. The method according to claim 5, wherein the high pressure container is rotated while the closure and the bottom part are laser welded.

12. A pressure unit comprising a high pressure container with a bottom part and a closure with a pressure control device, which pressure units are to be mounted in a fluid container, the pressure unit being prepared by a process comprising the steps of:
(a) automatically mounting the closure and the bottom part with the high pressure container to a pressure unit;
(b) welding the closure and the bottom part with the high pressure container to a pressure unit;
(c) pre-assembling the pressure unit and the container; and
(d) welding the container to the pressure unit.
